(19) United States
(12) Patent Application Publication
(10) Pub. No.: US 2025/0057131 A1
(43) Pub. Date: Feb. 20, 2025

(54) Salmon Net Picking Tool on a Retractable Spool

(71) Applicant: Hannah Prescott, Homer, AK (US)

(72) Inventor: Hannah Prescott, Homer, AK (US)

(21) Appl. No.: 18/405,241

(22) Filed: Jan. 5, 2024

Related U.S. Application Data
(60) Provisional application No. 63/459,663, filed on Apr. 16, 2023.

(51) Int. Cl. A01K 75/00; A45F 5/00

(52) U.S. Cl. CPC A01K 75/00; A45F 5/004

(57) ABSTRACT

A salmon net picking tool on a retractable spool. Salmon fishers use something called a net picking tool to pull fish that get caught in the netting. This fishing net picking tool is important to keep close by at all times when pulling fish out of the ocean. However, it is also very important for fishermen to keep their hands free as the ship sways. The salmon net picking tool on a retractable spool helps resolve both issues.

### BACKGROUND OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include hardware components or modules that, for purposes of discussion, may be illustrated and described as if the majority of the components were implemented solely in hardware. It should be noted that a plurality of hardware devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

### SUMMARY OF THE INVENTION

Salmon fishers use something called a net picking tool to pull fish that get caught in the netting. This fishing net picking tool is important to keep close by at all times when pulling fish out of the ocean. However, it is also very important for fishermen to keep their hands free as the ship sways.

The present subject matter places salmon net picking tool on a retractable spool so fishermen are able to keep their hands free why navigating a moving ship and still have the tool readily available when pulling fish out of the ocean.

### BRIEF DESCRIPTION OF DRAWINGS

FIG. 1 shows a side view of a salmon net picking tool on a retractable spool.

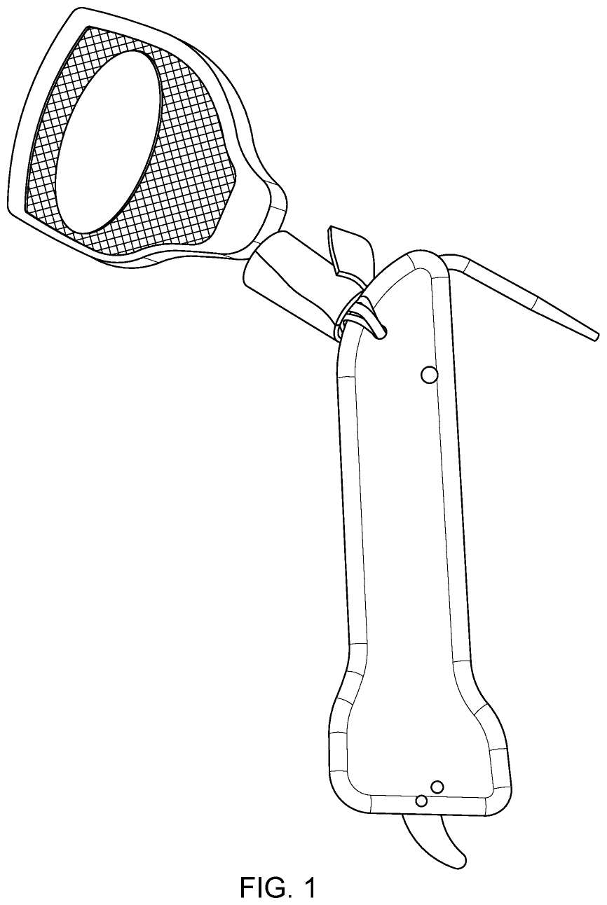

### DETAILED DESCRIPTION OF THE INVENTION

The salmon net picking tool on a retractable spool comprises of a handle with a small metal spike meant to lodged into the gills of a fish that is caught in the netting. This handle is then affixed to a retractable spool of a suitable length for typical use. The retractable spool is able to be attached to the fishermen's belt loop or jacket while not in use.

While several illustrative embodiments of the invention have been shown and

described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

1. A salmon net picking tool on a retractable spool comprising of a handle, spike, retractable spool, and a latching mechanism.

2. The salmon net picking tool on the retractable spool comprising of the handle, spike, retractable spool, and the latching mechanism as in claim 1, wherein the spool is affixed to the handle and latching mechanism.

3. The salmon net picking tool on the retractable spool comprising of the handle, spike, retractable spool, and the latching mechanism as in claim 1, wherein the latching mechanism is affixed to the user.

4. The salmon net picking tool on the retractable spool comprising of the handle, spike, retractable spool, and the latching mechanism as in claim 1, wherein the handle is affixed to the spike which is used to remove fish trapped in netting.

5. A method of manufacturing a salmon net picking tool on a retractable spool comprising of a handle, spike, retractable spool, and a latching mechanism.

6. The method of manufacturing the salmon net picking tool on the retractable spool comprising of the handle, spike, retractable spool, and latching mechanism as in claim 6, wherein the spool is affixed the handle and latching mechanism.

7. The method of manufacturing the salmon net picking tool on the retractable spool comprising of the handle, spike, retractable spool, and latching mechanism as in claim 6, wherein the latching mechanism is affixed to the user.

8. The method of manufacturing the salmon net picking tool on the retractable spool comprising of the handle, spike, retractable spool, and latching mechanism as in claim 6, wherein the handle is affixed to the spike which is used to remove fish trapped in netting.

9. A method of using a salmon net picking tool on a retractable spool comprising of a handle, spike, retractable spool, and a latching mechanism.

10. The method of using the salmon net picking tool on the retractable spool comprising of the handle, spike, retractable spool, and latching mechanism as in claim 8, wherein the spool is affixed the handle and latching mechanism.

11. The method of using the salmon net picking tool on the retractable spool comprising of the handle, spike, retractable spool, and latching mechanism as in claim 8, wherein the latching mechanism is affixed to the user.

12. The method of using the salmon net picking tool on the retractable spool comprising of the handle, spike, retractable spool, and latching mechanism as in claim 8, wherein the handle is affixed to the spike which is used to remove fish trapped in netting.
